(19) United States
(12) Patent Application Publication
(10) Pub. No.: US 2006/0159512 A1
(43) Pub. Date: Jul. 20, 2006

(54) Foam applicator

(76) Inventors: Gary Ashe, Sanborn, NY (US); Jeff Kalinowski, Cheektowaga, NY (US); Clint Winter, Holland, NY (US)

Correspondence Address: WALTER W. DUFT;LAW OFFICES OF WALTER W. DUFT, 8616 MAIN ST, SUITE 2, WILLIAMSVILLE, NY, 14221, US

(21) Appl. No.: 11/038,771

(22) Filed: Jan. 19, 2005

(51) Int. Cl. B43K 5/00

(52) U.S. Cl. 401/196

(57) ABSTRACT

An improved foam applicator for applying fluid material to a surface, in which the handle and the fluid carrier portion of the applicator are each made substantially from foam. The handle can be made from a first foam member, the fluid carrier can be made from a second foam member, and an adhesive can be used to interconnect the first and second foam members. To manufacture the foam applicator, a foam handle material and a foam fluid carrier material are selected and bonded together to form a composite foam assembly embodying the applicator. To improve manufacturing efficiency, the foam handle material may comprise a strip of sufficient length to form plural instances of the handle, and the foam fluid carrier material may comprise a strip of sufficient length to form plural instances of the fluid carrier. Individual applicators can then be cut out following bonding of the foam handle material to the foam fluid carrier material.

### CROSS REFERENCE TO RELATED APPLICATIONS

Not Applicable

### BACKGROUND OF THE INVENTION

1. Field of the Invention

The present invention relates to apparatus for applying fluid materials to surfaces, and particularly paint brushes.

2. Description of the Prior Art

By way of background, there are many varieties of foam applicators for use in the application of fluid materials to surfaces. Paint brushes are one common example. Such applicators typically comprise a handle made of wood or plastic and a porous polymeric foam member for carrying the fluid to be applied. The primary advantage of such applicators is that they are relatively low in cost and therefore disposable.

It is to improvements in the field of fluid applicators that the present invention is directed. In particular, the invention addresses the continuing need for a fluid applicator, and particularly a foam applicator, that is low in cost while being designed for maximum ergonomic efficiency.

### SUMMARY OF THE INVENTION

In accordance with the present invention, an improved foam applicator for applying fluid material to a surface includes a handle and a fluid carrier portion that are each made substantially from foam. By virtue of this simple construction, the applicator can be produced at minimal cost and will be extremely lightweight and comfortable in the hand of a user. The foam applicator of the invention can be embodied in various forms of construction, but will usually be implemented with the handle being made from a first foam member and the fluid carrier being made from a second foam member. An adhesive can be used to interconnect the first and second foam members into a composite unit. In a most preferred construction, the first foam member forming the handle will be relatively stiff and non-absorbent while the second foam member forming the fluid carrier will be relatively soft and absorbent.

The invention further contemplates a method for manufacturing a foam applicator in which a foam handle material and a foam fluid carrier material are selected and bonded together to form a composite foam assembly embodying the applicator. In exemplary embodiments of the invention, the foam handle material comprises a strip of sufficient length to form plural instances of the handle, and the foam fluid carrier material comprises a strip of sufficient length to form plural instances of the fluid carrier. The method will then further include cutting out individual applicators following bonding of the foam handle material to the foam fluid carrier material.

### BRIEF DESCRIPTION OF THE DRAWING

The foregoing and other features and advantages of the invention will be apparent from the following more particular description of exemplary embodiments of the invention, as illustrated in the accompanying Drawing in which:

FIG. 1 is a plan view of a foam applicator constructed in accordance with the present invention;

FIG. 2 is a side view of the foam applicator of FIG. 1;

FIG. 3 is an exploded view of the foam applicator of FIG. 1;

FIGS. 4A, 4B and 4C are perspective views showing a sequence of assembly steps that can be used to manufacture the foam applicator of FIG. 1;

FIG. 5 is a combined plan view and end view showing a composite foam assembly formed during manufacturing and embodying multiple foam applicators according to FIG. 1;

FIG. 6 is a plan view of a die cutter that can be used to cut multiple foam applicators according to FIG. 1 from the composite foam assembly of FIG. 5;

FIG. 7 is a plan view of another foam applicator constructed in accordance with the present invention;

FIG. 8 is a side view of the foam applicator of FIG. 7; and

FIG. 9 is a combined plan view and end view showing a composite foam assembly formed during manufacturing and embodying multiple foam applicators according to FIG. 7.

### DETAILED DESCRIPTION OF PREFERRED EMBODIMENTS

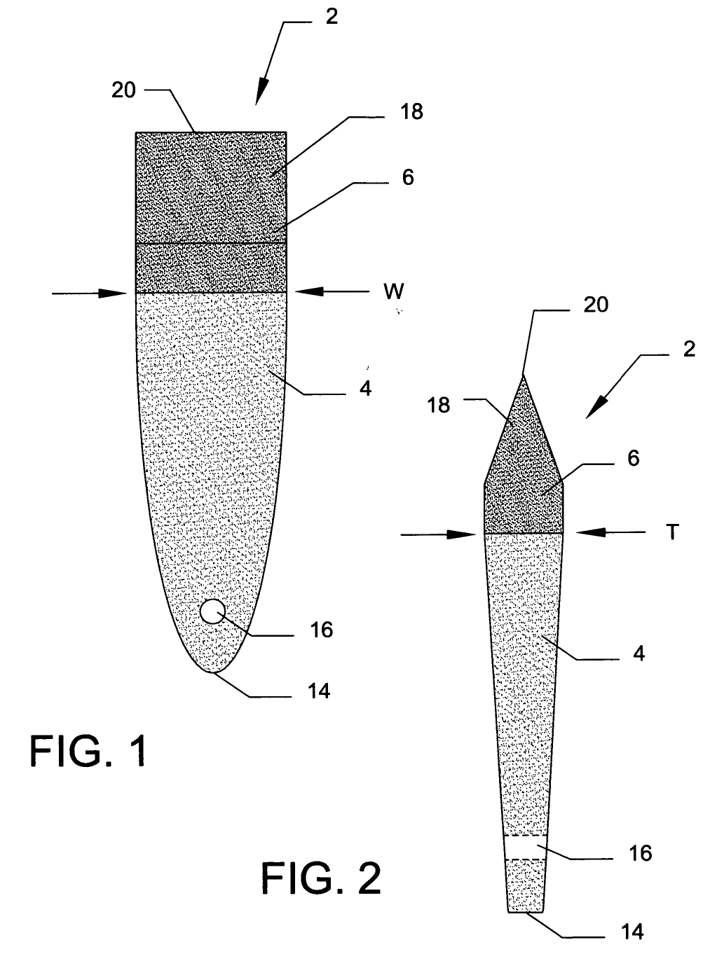

Turning now to the figures, wherein like reference numerals represent like elements in all of the several views, FIGS. 1-3 illustrate a foam applicator 2 constructed in accordance with one exemplary embodiment of the present invention. The applicator 2 is adapted to facilitate the manual application of fluid material to a surface. Such materials can include, but are not necessarily limited to, paint products, in which case the applicator 2 would function as a paint brush.

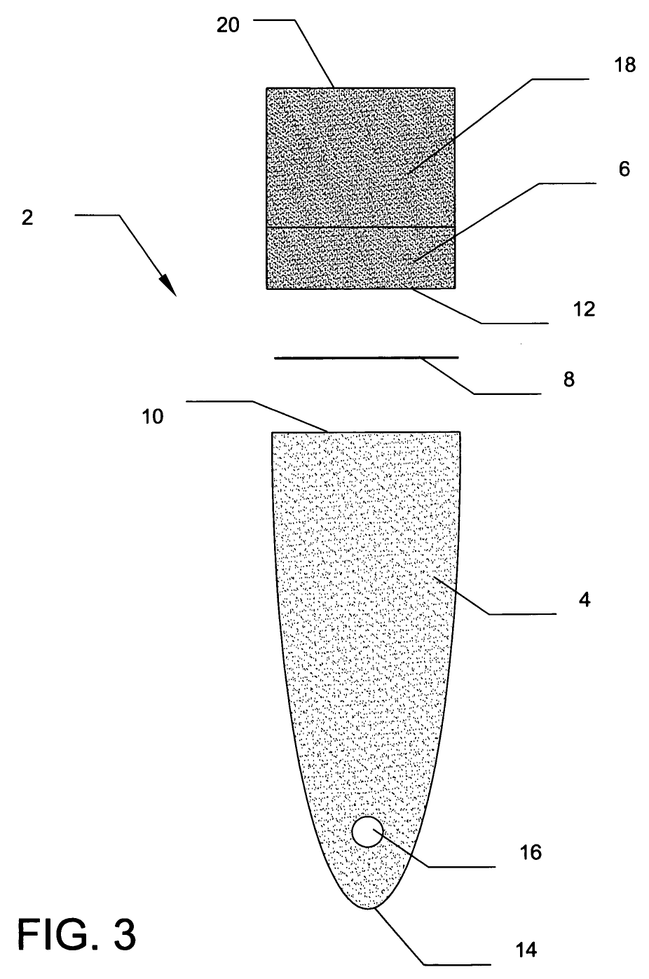

The foam applicator 2 includes a handle 4 and a fluid carrier portion 6, both of which are made of foam. The handle 4 is preferably made from a first foam member and the fluid carrier 6 is preferably made from a second foam member. A hot melt adhesive 8 (best shown in FIG. 3) is used to join the handle 4 made from the first foam member to the fluid carrier 6 made from the second foam member. Preferably, a layer of the adhesive 8 substantially covers the respective interconnecting faces 10 and 12 of the handle 4 and the fluid carrier 6 (see FIG. 3). In this way, a strong adhesive bond will be obtained. Moreover, the adhesive 8 can serve as a fluid barrier so that fluid material held by the fluid carrier 6 is retained therein. As an alternative to adhesive bonding, it may be possible to use a welding process or other means to interconnect the handle 4 and the fluid carrier 6. It will be appreciated that the applicator 2 could also be formed from a single foam member that embodies both the handle 4 and the fluid carrier 6. However, this could lead to the wicking of fluid from the fluid carrier 6 to the handle 4. Moreover, as described in the ensuing paragraph, foams that are well suited for use as a fluid carrier may not be particularly well adapted for use as a handle, and visa versa.

The first foam member used for the handle 4 is preferably stiffer and less absorbent than the second foam member used for the fluid carrier 6 in order to facilitate manual handling of the applicator 2. In particular, the stiff and nonabsorbent material of the handle 4 will allow that component to be firmly grasped and manipulated by a user during fluid application to a surface, and will not absorb fluid from the fluid carrier. In contrast, the second foam member used for the fluid carrier 6 is preferably softer and more absorbent than the first foam member used for the handle 4 in order to facilitate the delivery and application of fluid to a surface. In particular, the soft and absorbent material of the fluid carrier 6 will allow that component to carry are reasonable load of fluid from a fluid source, and will enable the fluid to be evenly distributed over a surface during strokes of the applicator. In an exemplary construction, the first foam member used to provide the handle 4 comprises polyethylene foam and the second foam member used to provide the fluid carrier 6 comprises polyether foam. The first foam member used for the handle 4 is preferably close-celled and nonreticulated, while the second foam member used for the fluid carrier 6 is preferably open-celled and reticulated. Alternatively, the first foam member and the second foam member could both be open-celled and reticulated. If desired, the foams used to produce the handle 4 and the fluid carrier 6 may be treated with a colorant to signify that the applicator 2 is for use with particular types of fluid. The color may be the same for both the handle 4 and the fluid carrier 6, or these components may be of different color.

One advantage of using the foam handle 4 is that the applicator 2 will be extremely light in weight, thus allowing it to be used for extended periods without fatigue. The foam handle 4 is also shaped to maximize user comfort. For example, it will be seen in FIGS. 1-3 that the handle 4 and the fluid carrier 6 of the applicator 2 are substantially co-equal in cross-sectional size at the respective interconnecting faces 10 and 12 thereof situated on each side of the adhesive 8 (best shown in FIG. 3). This means that the width dimension “W” in FIG. 1 and the thickness dimension “T” in FIG. 2 will be substantially the same for both the handle 4 and the fluid carrier 6 at each face 10 and 12. This feature results in the handle 4 having sufficient width and thickness to comfortably fit in a user's hand. This is in contrast to prior art fluid applicators wherein the handle is a slender wooden dowel or a flat plastic element that may tire the hand after an extended period of use. The surfaces of the handle 4 are also ergonomically tapered from the handle face 10 to a tip 14 of smaller cross-sectional size situated at the free end of the handle. In particular, in the plan view orientation of FIG. 1, the surfaces of the handle 4 that define its width are tapered to form a parabolic profile. In the side view orientation of FIG. 2, the surfaces of the handle 4 that define its thickness are tapered to form a thin trapezoidal profile. By so constructing the handle 4, it will be especially comfortable in the hands of children who wish to use the applicator for arts and crafts projects. However, it will be appreciated that many other handle configurations could also be used. As shown in FIGS. 1 and 3, the handle 4 may also be provided with a small hole 16 adjacent its free end to facilitate point-of-purchase display at a store or other venue. As best shown in FIG. 2, the fluid carrier 6 of the applicator 2 can be configured with a tapered rooftop profile 18 to define a tip 20 that facilitates fluid application.

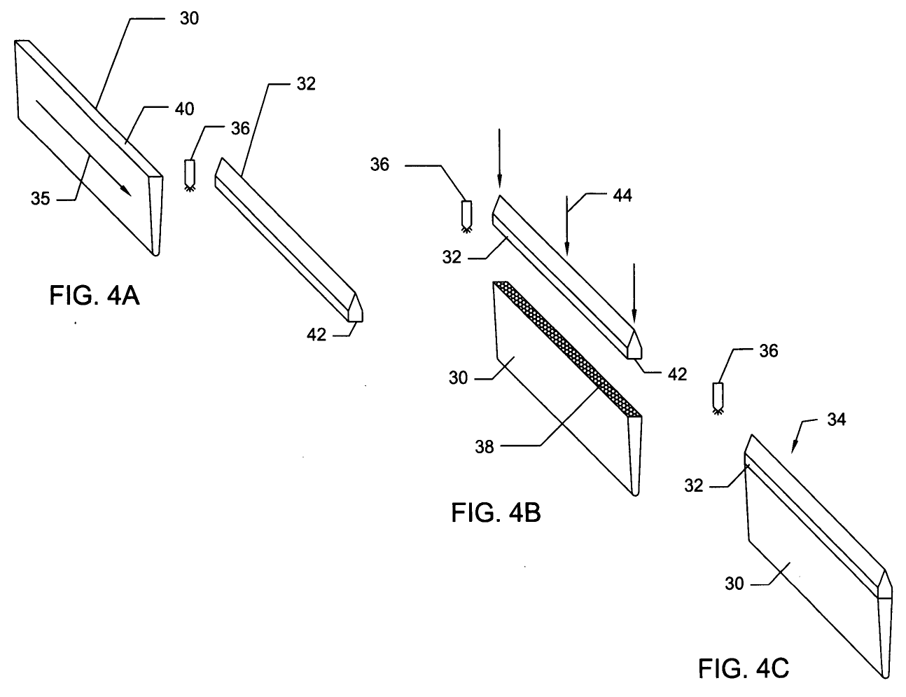

Turning now to FIGS. 4A, 4B and 4C, a method for manufacturing the applicator 2 entails the selection of a foam handle material strip 30 and a foam fluid carrier material strip 32 (FIG. 4A), and the bonding of these strips (FIG. 4B) to form a composite foam assembly 34 (FIG. 4C). The bonding operation is performed with the handle material strip 30 and the fluid carrier material strip 32 placed in clamping fixtures (not shown) so that they are oriented substantially as shown in FIG. 4A. The handle material strip 30 is then moved in the direction of the arrow labeled 35 in FIG. 4A. As the handle material strip 30 is so moved, it passes under a hot melt nozzle 36 and a quantity of hot melt adhesive 38 is dispensed onto the strip's exposed upper surface 40 (see FIG. 4B). Over the course of the next eight seconds (approximately), the upper surface 40 of the handle material strip 30 will be substantially covered with a thin layer of the adhesive 38. At this point, the bottom surface 42 of the fluid carrier material strip 32 is firmly pressed by way of a downward force 44 onto to the adhesive-covered surface 40 of the handle material strip 30 (FIG. 4B). The handle material strip 30 and the fluid carrier material strip 32 are maintained in this state for approximately 15-30 seconds to allow the adhesive 38 to cool and set so that the two strips are bonded together to produce the composite foam assembly 34 of FIG. 4C.

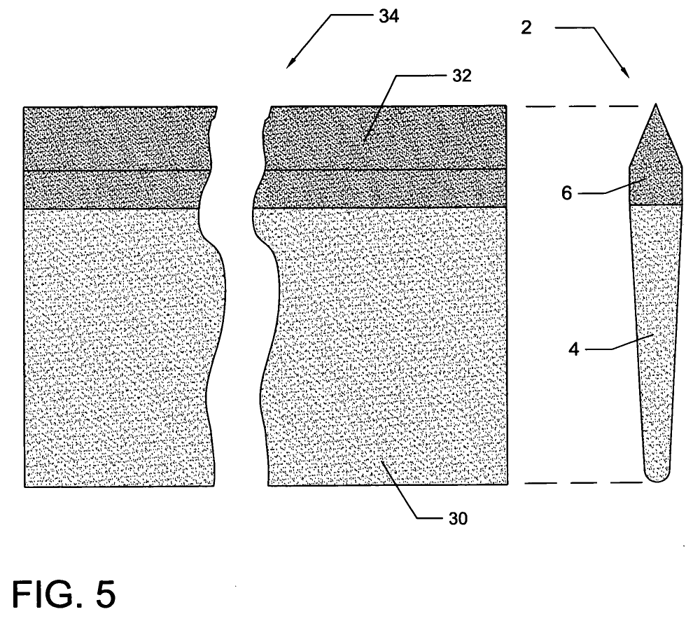

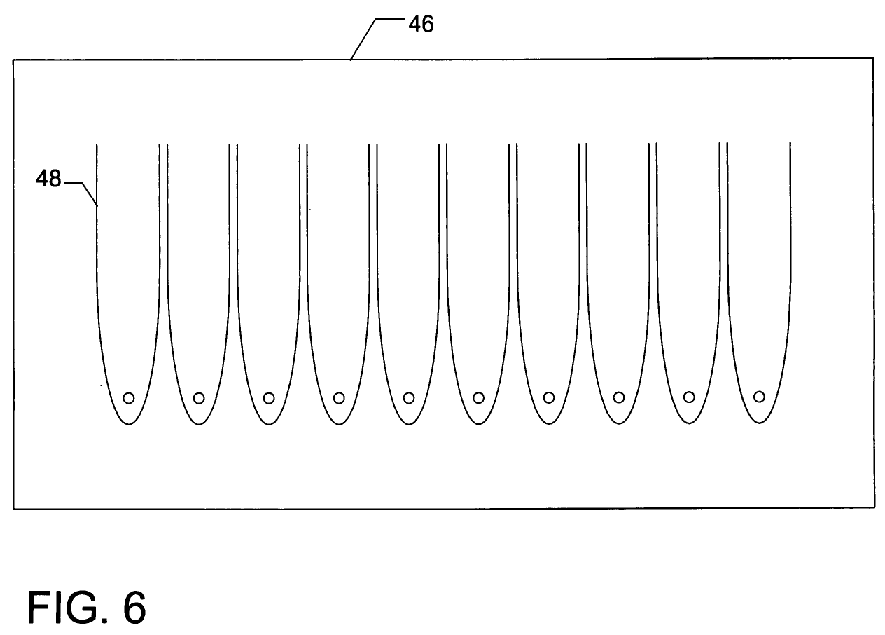

The handle material strip 30 and the fluid carrier material strip 32 are preferably shaped to produce a desired first applicator profile as a result of the bonding operation. As shown in FIG. 5, the first applicator profile defined by bonding the handle material strip 30 to the fluid carrier material strip 32 is the tapered side view profile of the applicator 2 shown in FIG. 2. To obtain this profile, the handle material strip 30 can be formed via a foam extrusion process (e.g., with polyethylene foam) using an extruder (not shown) that defines the tapered side view shape of the handle 4 in FIG. 5. Similarly, the fluid carrier material strip 32 can be formed via a foam molding process (e.g., with polyether foam) using a mold (not shown) that defines the tapered side view shape of the fluid carrier 6 in FIG. 5.

With the side view profile of the applicator 2 being defined by the handle material strip 30 and the fluid carrier material strip 32, a second desired applicator profile can be produced by way of a cutting operation that separates the composite assembly 34 of FIGS. 4C and 5 into plural instances of the applicator 2. As shown in FIG. 6, cutting can be performed with a die cutter 46 having a row of plural cutting elements 48 to cut multiple applicators in a single cutting operation. It is assumed, of course, that the handle material strip 30 and the fluid carrier material strip 32 are both of sufficient length to respectively form plural instances of the handle 4 and the fluid carrier 6 of FIGS. 1-3, and thus plural applicators 2.

It will be seen that the cutting elements 48 are shaped so that the second applicator profile is the tapered plan view profile of the applicator 2 shown in FIG. 1. In this way, the cutting operation will complete the formation of individual instances of the applicator 2, with both of the tapered width and thickness profiles being precisely defined. Note that the cutting element 48 is further adapted to produce the applicator's mounting hole 16.

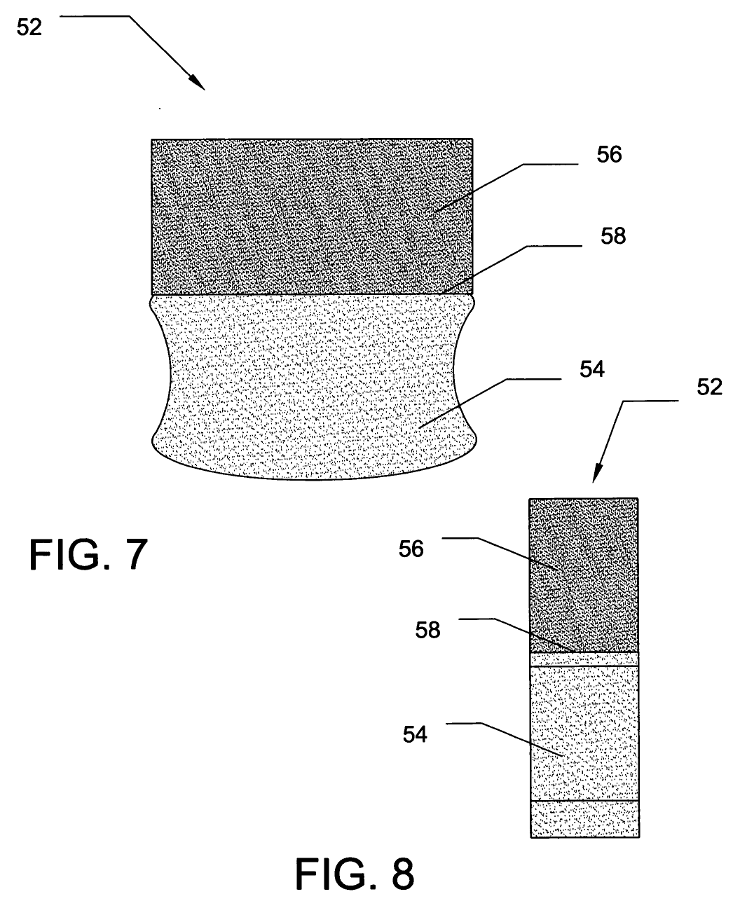

Turning now to FIGS. 7 and 8, a second applicator 52 is constructed in accordance with another exemplary embodiment of the present invention. The applicator 52 illustrates how a relatively minor design variation can give rise to a slightly modified manufacturing technique that is arguably simpler that the process described above relative to FIGS. 4A-4C. The applicator 52 comprises a foam handle 54 and a foam fluid carrier 56 that are bonded to each other by way of an adhesive 56 (other bonding techniques could also be used). The materials used for these components may considered to be the same as their counterparts in the applicator 2 of FIGS. 1-3. The principal feature of the applicator 52 is that the plan view and side view profiles respectively shown in FIGS. 7 and 8 are different from the counterpart plan view and side view profiles of the applicator 2 shown in FIGS. 1 and 2. In FIG. 7, it will be seen that the applicator 52 is shorter and wider than the applicator 2, and that the handle 54 has undulating tapered sides to facilitate gripping. In FIG. 8, it will be seen that the applicator 52 has no taper in either the handle 54 or the fluid carrier 56.

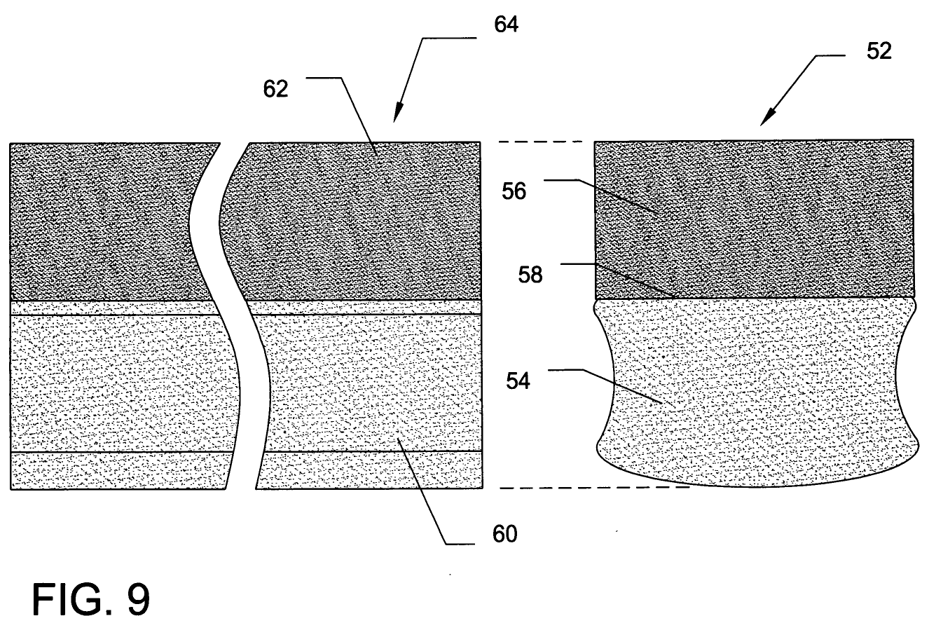

The non-tapered side view design of the applicator 52 means that this applicator can be manufactured in a different manner than the applicator 2. Specifically, as shown in FIG. 9, the applicator 52 can be produced by bonding together the handle and fluid carrier material strips 60 and 62 so as to form a composite foam assembly 64 whose cross-sectional shape is the tapered plan view profile shown in FIG. 7. Considering the non-tapered side view profile of FIG. 8, it will be appreciated that single instances of the applicator 52 can be formed by repeatedly cutting the composite assembly at spaced locations, in much the same manner as loaf of bread is sliced. This means that a simple cutting blade can be used for the cutting operation instead of a die cutter as used to produce the applicator 2.

Accordingly, an improved foam applicator for use with fluid materials has been disclosed in which the applicator handle and the fluid carrier portion thereof are substantially made from foam. While various embodiments of the invention have been shown and described, it should be apparent that many variations and alternative embodiments could be implemented in accordance with the invention. For example, although manufacturing cost would be increased, it would be possible to introduce non-foam components into the applicator without departing from the basic concept of the invention. For example, the handle and/or areas of the fluid carrier of the applicator could be coated with paint, latex material or some other desired covering. Similarly, a piece of reinforcing plastic could be introduced within the interior of the handle and/or portions of the fluid carrier of the applicator to enhance stiffness. In all such cases, it is considered that the handle and the fluid carrier would still be made substantially from foam. It is understood, therefore, that the invention is not to be in any way limited except in accordance with the spirit of the appended claims and their equivalents.

What is claimed is:

1. A foam applicator for applying fluid material to a surface comprising a handle and a fluid carrier portion, said handle and said fluid carrier each being made substantially from foam.

2. A foam applicator in accordance with claim 1, wherein said handle comprises a first foam member of a first foam material and said fluid carrier comprises a second foam member of a second foam material.

3. A foam applicator in accordance with claim 2, wherein first foam member is bonded to said second foam member.

4. A foam applicator in accordance with claim 3, wherein said bonding is provided by a hot melt adhesive.

5. A foam applicator in accordance with claim 4, wherein said first foam member is stiffer and less absorbent than said second foam member, and said second foam member is softer and more absorbent than said first foam member.

6. A foam applicator in accordance with claim 5, wherein said first foam member comprises polyethylene foam and said second foam member comprises polyether foam.

7. A foam applicator in accordance with claim 6, wherein said first foam material is closed-celled and nonreticulated, and said second foam material are is open-celled and reticulated.

8. A foam applicator in accordance with claim 7, wherein said handle and said fluid carrier are substantially co-equal in cross-sectional size at their point of interconnection.

9. A foam applicator in accordance with claim 8, wherein said handle comprises tapered surfaces that produce first and second tapered profiles.

10. A foam applicator in accordance with claim 9, wherein said handle and said fluid carrier are of different color.

11. A method for manufacturing a foam applicator for applying fluid material to a surface comprising a handle and a fluid carrier portion each being made substantially from foam, comprising:
selecting a foam handle material;
selecting a foam fluid carrier material; and
joining said foam handle material to said foam fluid carrier material to form a composite foam assembly embodying said applicator.

12. A method in accordance with claim 11, wherein said foam handle material comprises a strip of sufficient length to form plural instances of said handle, said foam fluid carrier material comprises a strip of sufficient length to form plural instances of said fluid carrier, and said method further comprises cutting individual foam applicators following joining of said foam handle material strip to said foam fluid carrier material strip.

13. A method in accordance with claim 12, wherein said foam handle material strip and said fluid carrier material strip are shaped to produce a desired first applicator profile as a result of said joining.

14. A method in accordance with claim 13, wherein said cutting is performed in a manner that produces a desired second foam applicator profile.

15. A method in accordance with claim 14, wherein said cutting is performed with a die cutter that cuts multiple applicators in a single cutting operation.

16. A method in accordance with claim 11, wherein said joining comprises a bonding process performed using a hot melt adhesive placed between said handle material and said fluid carrier material.

17. A method in accordance with claim 12, wherein said bonding is performed by dispensing a quantity of hot melt adhesive on a surface of said handle material strip, placing a surface of said fluid carrier material strip on said adhesive, and allowing said adhesive to cool and set.

18. A foam applicator for applying fluid material to a surface, comprising:
a handle;
a fluid carrier;
said handle and said fluid carrier each being made substantially from foam;
a fluid barrier disposed between said handle and said fluid carrier;
said handle comprising a first foam member of a first foam material and said fluid carrier comprising a second foam member of a second foam material;
said first foam member and said second foam member being interconnected by hot melt adhesive;
said first foam member being stiffer and less absorbent than said second foam member;
said second foam member being softer and more absorbent than said first foam member;
said first foam member comprising polyethylene and said second foam member comprising polyether;
said first foam member being close-celled and nonreticulated, and said second foam member being open-celled and reticulated;
said handle and said fluid carrier being substantially co-equal in cross-sectional size at their point of interconnection; and
said handle comprising tapered surfaces that produce first and second tapered profiles.

19. A method in accordance with claim 18, wherein said handle and said fluid carrier are of different color.

20. A method in accordance with claim 19, wherein said applicator is a paint brush.
